(19) United States
(12) Patent Application Publication
(10) Pub. No.: US 2011/0093420 A1
(43) Pub. Date: Apr. 21, 2011

(54) COMPUTER-PROCESSING SYSTEM SCORING SUBJECTS RELATIVE TO POLITICAL, ECONOMIC, SOCIAL, TECHNOLOGICAL, LEGAL AND ENVIRONMENTAL (PESTLE) FACTORS, UTILIZING INPUT DATA AND A COLLABORATION PROCESS, TRANSFORMING A MEASUREMENT VALUATION SYSTEM REGARDING THE VALUE OF SUBJECTS AGAINST AN AGENDA

(76) Inventors: Erik Rothenberg, Playa Del Ray, CA (US); Kevin Goldberg, Westlake Village, CA (US); William J. Salak, Newbury Park, CA (US); Jeannette Draper, Venice, CA (US)

(21) Appl. No.: 12/905,521

(22) Filed: Oct. 15, 2010

Related U.S. Application Data
(60) Provisional application No. 61/252,254, filed on Oct. 16, 2009.

(51) Int. Cl. G06N 5/00; G06F 17/00

(52) U.S. Cl. 706/45

(57) ABSTRACT

A method for computing a universal sustainability index comprising the steps of creating a network, inviting participants to join the network, gathering participant data, imputing contributed data by the participants and transforming the contributed data via a computer to obtain a universal sustainability index or alphanumeric indicator. Participant data is gathered utilizing surveys, tests, questionnaires. Contributed data is imputed from participants and comprises attributes, sub-attributes, statements, sub-statements, subjects, raw values, range bottoms, range tops, percent weights, polarity, third party data, and the like. The contributed data is then transformed to obtain a universal sustainability index or alphanumeric indicator, wherein the universal sustainability score or collection of scores comprises an indicator, and wherein the indicator is a numerical value of a selected subject, or comprises an index wherein the index is a numerical value of a selected agenda or sub-agenda.

### CROSS-REFERENCE TO RELATED APPLICATIONS

The present application is a non-provisional patent application and claims priority to, and full benefit of, provisional patent application Ser. No. 61/252,254 entitled “COMPUTER-PROCESSING SYSTEM SCORING SUBJECTS RELATIVE TO EARTH, CLIMATE, AND SOCIETY, UTILIZING INPUT DATA AND A COLLABORATION PROCESS, TRANSFORMING A MEASUREMENT VALUATION SYSTEM REGARDING THE VALUE OF SUBJECTS”, filed on Oct. 16, 2009, the entire contents of which are hereby incorporated by reference. The present application is related to non-provisional patent application Ser. No. 12/182,561, entitled “METHOD FOR GENERATING A COMPUTER-PROCESSED FINANCIAL TRADABLE INDEX”, filed Jul. 30, 2008, the entire contents of which are hereby incorporated by reference. The present application is related to non-provisional patent application Ser. No. 12/275,550, entitled “METHOD FOR MODIFYING THE TERMS OF A FINANCIAL INSTRUMENT”, filed Nov. 21, 2008, the entire contents of which are hereby incorporated by reference. The present application is related to non-provisional patent application Ser. No. 12/579,621, entitled “METHOD FOR GENERATING BUSINESS INTELLIGENCE”, filed Oct. 15, 2009, the entire contents of which are hereby incorporated by reference.

### FEDERALLY SPONSORED RESEARCH OR DEVELOPMENT

None

### PARTIES TO A JOINT RESEARCH AGREEMENT

None

### REFERENCE TO A SEQUENCE LISTING

None

### BACKGROUND OF THE INVENTION

1. Technical Field of the Invention

The invention relates to the information technology field of business intelligence. In the case of the invention, business intelligence tools are utilized in the context of a robust and interactive computer processing model that will enable community-based measurements and social voting against any given agenda, and which in turn may transform into a sustainability value indicator reflecting the impact upon and potential of reaching “universal sustainability” defined as a balance of PESTLE factors in any given context (i.e. local, regional, global, organization-wide, etc.) serving the highest quality of life for all life within said context.

2. Description of Related Art

Efforts to quantify PESTLE variables are wide and varied and often take the form of so-called “composite indicators” and “composite indices”, using often conflicting measurement techniques and standards. For the economy, there is the Composite of Leading Indicators (OECD), The Economic Freedom of the World Index (Economic Freedom Network), Economic Sentiment Indicator and Business Climate Indicator (EC), among others; for the environment there is the Environmental Sustainability Index (World Economic Forum), and Sustainable Development Index (UN), among others; for globalization, there is the Global Competitiveness Report (World Economic Forum) and the Globalization Index (World Markets Research Centre), among others; for society and governance, there is the Human Development Index (UN), Corruption Practices Index (Transparency International) and the Overall Health Attainment (World Health Organization), among others; finally, for innovation and technology, there is the Technology Achievement Index (UN), the Performance in Knowledge based Economy (EC) and National Innovation Capacity Index (Porter and Stern), among others.

In spite of such various “composite indices” proliferating as prior art, with hundreds of such indices and standards in the field of sustainability alone, critically, there presently exists no globally accepted measurement system or standards and/or rating process for universal sustainability that is dynamically inclusive, accurate, meaningful and participatory by all stakeholders in PESTLE factors. Further, the manner in which such composite indices are compiled is necessarily limiting from an enfranchisement point of view, does not include sentiment evaluations, and is limiting in scope of analysis due to funding, data commensurability or perspective.

The related art may be referenced in certain contexts to R. Buckminster Fuller's coining of the term Comprehensive Anticipatory Design Science. Fuller spoke of “ . . . the search for the principles governing the Universe and [to] help advance the evolution of humanity in accordance with them . . . finding ways of doing more with less to the end that all people everywhere can have more and more”, and boldly asked “How can we make the world work for 100% of humanity, in the shortest possible time, through spontaneous cooperation, without ecological damage or disadvantage to anyone?”

R. Buckminster Fuller noted that a future world in which higher context thinking was enabled must serve the following constraints; comprehensive: a clear demonstration of holistic systems thinking; anticipatory: protectively tracking critical trends and needs, identifying and assessing long term consequences of proposed solutions; ecologically responsible: reflective and supportive of nature's underlying processes, patterns and principles; verifiable: able to withstand rigorous empirical testing; replicable: capable of being readily undertaken by others; achievable: likely to be implemented successfully and broadly adopted. The invention undertakes Fuller's legacy in its design principles.

The invention's primary directive, and a key function of the related art, is to create a framework that enables ongoing dynamic input by a community of participants, so that they may arrive in an enfranchised, open way at a value of any subject measured against an agenda of universal sustainability for any given context at any given moment for any given subject. Upon obtaining this scoring, rating, value, or insight the community may be able to support decision-making in the service of the highest quality of life for all life in that context, as set by a given agenda supporting such aims.

The informed decision-making supports a virtuous cycle of value creation in the service of universal sustainability that in turn supports alternative socio-economic systems tied to the creation of ever-greater natural, social and physical assets and equity shared by ever-greater participants and stakeholders, eventually fulfilling Fuller's vision of the expected results of Comprehensive Anticipatory Design Science and more.

Therefore, it is readily apparent that there is a need for a measurement system supporting for exemplary purposes only and without limitation, rating, scoring, indexing, valuation, modeling, critical path, and decision making and a method for scoring or rating any subject in relationship to an agenda of universal sustainability.

### BRIEF SUMMARY OF THE INVENTION

Briefly described, in a preferred embodiment, the present invention meets the recognized need for such an apparatus by providing a business intelligence system which uses a methodology and system for scoring subjects relative to an agendum of universal sustainability, wherein the word “business” in “business intelligence system” refers to a collection of activities carried on for whatever purpose, for example, science, technology, commerce, industry, law, government, and the like, and wherein, the word “intelligence” in “business intelligence system” refers to the ability to understand the interrelationships of presented facts, assumptions, predictions, estimations and subjective beliefs and opinions in such a way as to guide actions towards a desired agendum, and wherein the word “system” in “business intelligence system” refers to a regularly interacting group of factors operating as a whole. Using the business intelligence system in the context of serving “universal sustainability” in a given context, the system is a quantized hierarchy, capable of scoring subjects relative to universal sustainability and hence providing the basis for informed decision making. As well, said quantized hierarchy process may be employed to offer predictive results against universal sustainability and hence providing the basis for informed decision making. In addition, the invention lends itself to modeling, whereby the scoring mechanism and the predictive mechanism are combined into a system that drives a critical path towards universal sustainability and therefore provides the basis for informed decision making.

According to its major aspects and broadly stated, the present invention in its preferred form is a method for a method for generating a universal sustainability score comprising the steps of utilizing at least one computer processor to generate a taxonomy from data, assigning raw values to attributes, normalizing the raw values into scaled values, adjusting the scaled values into adjusted values, weighting the adjusted values into weighted values to calculate the weighted values, calculating the weighted values into statement weighted values and calculating the statement weighted values into agendum weighted values. The agendum weighted values are mathematically derived throughout the taxonomy utilizing the statement weighted values linked to the agendum, and the agendum weighted values are mathematically combined to generate the universal sustainability score.

Data comprises, for exemplary purposes only, statements, subjects, attributes, and combinations thereof. The data is contributed into the taxonomy by an entity. The entity is selected from the group consisting of artificial intelligence, input data from a plurality of networked users, captured data from a plurality of data sources, and combinations thereof.

Additionally, the data is related to PESTLE factors. The PESTLE factors comprise, for exemplary purposes only, political factors, economical factors, societal factors, technological factors, legal factors, environmental factors, and combinations thereof. The plurality of networked users comprises individuals skilled in a particular field and the plurality of networked users accumulates voting currency. The universal sustainability score comprises a numerical value is representative of PESTLE factors.

The step of assigning the raw values to the attributes further comprises the steps of assigning a range bottom to the attributes by the plurality of network users and assigning a range top to the attributes by the plurality of network users. The range bottom is the lowest acceptable numeric value for the raw values and the range top is the highest acceptable numeric value for the raw values. The raw values are then normalized on a numeric scale between the range bottom and the range top.

The step of adjusting the scaled values into the adjusted values further comprises the step of assigning a polarity to the scaled values. The polarity comprises, for exemplary purposes only, negative polarity, positive polarity, and combinations thereof.

The percent weights are defined by the plurality of networked users. The plurality of networked users directly input a numeric value for the percent weights and selectively expends voting currency to input a numeric value for the percent weights. The plurality of networked users selectively cast votes towards a numeric value to be inputted for the percent weights, and the votes systematically adjust the percent weights.

The statements in the taxonomy further comprise sub-statements. The statements support the agenda and are organized hierarchically under the agenda. The subjects comprise, for exemplary purposes only, a person, a place, a thing, and combinations thereof and the universal sustainability score is calculated for the subjects.

The attributes in the taxonomy further comprise sub-attributes. The sub-attributes sharing common attributes are linked together into attribute sets. The attribute sets produce unified weighted values for the attributes. The attributes are selectively linked to the statements, and the weighted values for the attributes are mathematically applied to the percent weights of linked statements.

The step of calculating the weighted values into the statement weighted values further comprises the steps of combining the weighted values of the attributes to mathematically derive attribute weighted totals for the attributes, selecting the sub-statements related to the attributes, multiplying the attribute weighted totals by sub-statement percent weights of the sub-statements to calculate sub-statement weighted values. The sub-statements are applicable to the attributes within the taxonomy, and the sub-statements inherit the attribute weighted totals. Additionally, the sub-statement percent weights are defined by, for exemplary purposes only, the voting currency, the votes, and combinations thereof.

The step of calculating the weighted values into the statement weighted values further comprises the steps of combining the sub-statement weighted values of the sub-statements to mathematically derive sub-statement weighted totals for the sub-statements, selecting the sub-statements linked to statements, multiplying the sub-statement weighted totals by statement percent weights of the statements to calculate statement weighted values and combining the statement weighted values of the statements to mathematically derive statement weighted totals for the statements.

Additionally, the step of calculating the statement weighted values into agendum weighted values further comprises the steps of selecting the statements to affect the agenda and multiplying the statement weighted totals by agenda percent weights of the agenda to calculate the agendum weighted values. The agenda percent weights are defined by, for exemplary purposes only, voting currency, the votes, and combinations thereof, and the agendum weighted values are a numerical score for generating the universal sustainability score.

The method for generating a universal sustainability score further comprises the steps of selecting the subjects by the plurality of networked users, calculating the weighted values for selected the subjects and combining the weighted values for selected the subjects to mathematically derive subject scores. The subject scores are an alphanumeric value indicator for the subject.

Additionally, the present invention is a method for generating an impact score comprising the steps of defining the subject, utilizing at least one computer processor to generate statements, attributes, and combinations thereof, assigning statement percent weights to the statements, assigning attribute percent weights to the attributes, inputting raw values into the attributes, multiplying the raw values with the attribute percent weights to derive attribute values, linking the statements, the attributes, and combinations thereof, multiplying the attribute values of the attributes linked to select the statements with the statement percent weights to derive statement values and combining together the statement values of the statements applicable to the subject to calculate the impact score.

The present invention further comprises a method for generating a subject score comprising the steps of defining the subject, utilizing at least one computer processor to generate attributes, sub-attributes and combinations thereof, assigning attribute percent weights to the attributes, inputting raw values into the attributes, multiplying the raw values with the attribute percent weights to derive attribute values and combining together the attribute values of the attributes applicable to the subject to calculate the subject score.

Additionally, the present invention is a method for generating a taxonomy comprising the steps of contributing data into the taxonomy, linking the sub-attributes to the attributes, linking the sub-statements to the statements; and organizing the data within the taxonomy into a modular hierarchy.

Computer-generated alphanumeric “universal sustainability value indicators” represent score, rating, indexing and values of subjects comprised of measuring the fully accounted for value of a subject against PESTLE factors informing universal sustainability. This is enabled by an online user community which contributes data, which in turn are put into appropriate ranges for context specific situation, in turn normalized and calculated against weighted and linked hierarchies of agenda statements and subject attributes related to an agendum of universal sustainability and a subject intending to be measured against such agendum.

The system processes criteria that account for political, economic, social, technological, legal and environmental (PESTLE) elements with respect to concepts of unified sustainability such as standard of care, good faith and fiduciary duty. These concepts are represented within subject attributes and agenda statements related to for exemplary purposes only and without limitation, conservation, restoration, and improvement of earth, climate and society, and intergenerational equity and enfranchisement thereof. Weighting of agenda statements and subject attributes and also range setting and polarity setting of numerical data elicited by attributes of subjects and within a subject taxonomy create a structure where the attributes of any subject can be normalized and subsequently linked to said agenda statement taxonomy to obtain a score or rating against said standard of universal sustainability.

The system processes and transforms input data in the form of objective facts, subjective opinions, ideals, predictions, estimations, beliefs assumptions (validated or unvalidated) and values, within a taxonomies of subject attributes and agenda statements related to universal sustainability that enables the comparison of any subject and its related attributes (or questions related to the subject that elicit numerical data) against said statement agenda taxonomy of sustainability for the purpose of obtaining a meaningful alphanumeric universal sustainability value indicator against the top agendum of the agenda statement taxonomy or at any level beneath it. The system enables a computer networked community, self-learning and adaptive and accountable to its own given mandate to achieve the statements in the agenda statement taxonomy regarding PESTLE factors, which in turn serve universal sustainability.

A measurement system and processing and transformation method, combined with a social voting enabled, importance—weighting feature, together with performance related input data on subjects, the result is a dynamic valuation against universal sustainability. The invention is a method that incorporates quantized hierarchies and taxonomies regarding PESTLE factors into an incremental and meaningfully expanded numeric and alphanumeric description of value and how that value serves the highest holistic fiduciary obligation with respect to said PESTLE factors supporting universal sustainability.

The invention in its most basic form will enable a community-defined measurement of universal sustainability.

In various embodiments and methods and forms, the invention will accomplish this purpose by: establishing a taxonomy of universal sustainability within a given context; enrolling a global online community to contribute to defining data and ranges that inform adaptive standards for achieving that goal; creating a linkage between subject attributes and statements in agendum taxonomy in order to create a score which can be described as single, unified and readily comparable number as an indicator or an index or a value or a rating at any level of the universal sustainability agenda taxonomy.

A social networking platform element enables, for exemplary purposes only, social voting for weighting and other determinations; subject matter expert collaboration; social and professional connections; learning and education; creating and editing personal and professional profiles; the definition of key performance indicators and ranges and weightings and polarities of said indicators; questions and issues to be voted upon; assumptions to be validated; problems to be solved; participant workflow to be mapped, tracked, communicated and credited; incentivizing of participation; integration of divergent points of view, psychological conditioning or other training and education of participants; linking and relationships; data normalization; general community enfranchisement.

Furthermore, a wiki-based platform enables, for exemplary purposes only, the mass contribution of data from subject matter experts; contribution of research to research library; contribution of expertise in taxonomical organization; contribution of intangibles; agenda statement and subject attribute weighting; contributions of subject data from corporations, regions, governments, individuals and others; community discussion and modification and updating of data; opening and holding space for new forms of data and collection techniques to be contributed and effected; collaborative production on measurements and steps needed to create such measurements; community self-policing; convenient and easy access to data and community participation.

The social network/wiki-based community engages in collaborative production of a hierarchy of statements, attributes, subjects and adaptive standards against a top level goal of universal sustainability, harmonizing measurement methods and types of data sets, augmented by the dynamic data and opinion updates of the community. The invention's measurements against a goal of universal sustainability are based upon combining objective data gathered from all participants and sources, along with subjective data gathered from community voting and other sentiment data sources to give the objective data additional layers of relevancy and meaning.

Furthermore, when all input data are established for a given subject and linked to appropriate taxonomical categories in the taxonomy of sustainability, an algorithm calculates the universal sustainability score. This score is a representation of a relative and/or an absolute measure of the subject against peer, or against a given branch in or whole of the universal sustainability agenda.

A key feature and advantage of the invention is the creation of a unified rating system; a comprehensive and interoperable measure of contribution of a given subject to the service of the top level agenda of universal sustainability or any branch thereof; a corporation and a product, for exemplary purposes only and without limitation, could therefore be compared to one another on the same “universal sustainability” score or rating or index at any level.

A key feature and advantage of the invention is the creation of a business process utilizing scores and rankings to solve sustainability problems, for exemplary purposes only, the optimal path to serve universal sustainability needs within a given context.

Furthermore, the invention proposes a novel method whereby raw and sentiment data may further be normalized and made commensurable from the standpoint of data interoperability enabling unlimited scope of analysis and data re-usability at the data, attribute, statement, branch or score levels.

A key feature and advantage of the invention is that the reference of the top level goal of universal sustainability is well-suited to solving the problems of data commensurability and normalization, which may be described as the ability to derive meaning from data sets of different natures and measurement protocols.

In another embodiment, relevant sentiment elicitation modules will be developed for community participants and results calibrated into a larger equation, resulting in greater enfranchisement and relevancy of meaning to the community.

Said collected data is then combined into an algorithm, formula and/or with the resulting universal sustainability score, indicator, value or rating is an overall evaluation of how a given subject scores on an absolute or relative basis against serving the top level agenda of universal sustainability.

Another feature and advantage of the invention is the assigning of comprehensive value and sentiment-based weightings to tiers in the agenda and subject taxonomies, highlighting elements of the human and natural worlds not considered in most scoring, rating or indexing protocols. The sustainability indicator measurement, for exemplary purposes only, will consider any community-determined PESTLE subject or subject attributes, in terms of their aggregate positive or detrimental effect on universal sustainability as defined in a given context and expressed in an agenda taxonomy. The indicator anticipates, a comprehensive, accurate, meaningful number, addressing everything in PESTLE factors related to universal sustainability in a unified way.

In an embodiment, the universal sustainability value indicator is a measurement of the contribution of a subject to PESTLE factors related to universal sustainability.

In still another embodiment, the universal sustainability indicator is a measurement comprising various interactions of all PESTLE components against an agenda, including both raw and sentiment data measurements, normalized, polarized and weighted into a unified rating system for sustainability.

In another embodiment, the universal sustainability indicator serves as a value underlyer, comprising a standard of value of a subject measured against the value of universal sustainability or PESTLE factors in a given context or at a given level of a taxonomy.

In another embodiment, the universal sustainability indicator is the underlyer upon which may be based measurements of baselines and variances for a given subject, for exemplary purposes only, comprising the basis of financially tradable products such as debt-based and equity-based securities and indices.

In yet another embodiment, the invention enables creation of multiple sustainability indices identifying, for exemplary purposes only, the performance of any given individual PESTLE factors or combinations thereof, for a subject, in meaningful combinations that serve portions of the goal of universal sustainability, for exemplary purposes only, social, legal and political elements only.

In yet another embodiment, the invention's community-generated sustainability value indicator and derived index, scoring and rating measurements are the basis of a standardized valuation system which may be applied to, for exemplary purposes only and without limitation, complementary and alternative currencies, virtual currencies and credits, so called “sustainability rates”, national currencies and currency trades, where said standardized value represents contribution toward universal sustainability in a given context.

In another method of this embodiment, the alphanumeric sustainability value indicators are used as common valuation standards and thus the underlyer for virtual and/or alternative currencies and their respective values. These values reflect the performance of the subject against the common valuation standard of universal sustainability, for exemplary purposes only, a geographic region, industry sector, government, corporation, ad-hoc community groups; such subjects may compare against one another, based on the common value standards in a given common context, and therefore forming the basis of an exchange not dependent on national currencies or instruments derived thereof such as national currency linked alternative currency or so called “special reserve” currencies that are a basket of national currencies.

Yet another key feature and advantage of the above currency embodiment is the ability for communities defined by, for exemplary purposes only and without limitation, geography, affiliation, sector, to develop their own value indices and exchanges between one another, tied to a common value underlyer of universal sustainability.

In an embodiment, sustainability value indicators, for exemplary purposes only and without limitation, a sustainability rate, a score, an index, true cost, true value, may themselves become a form of currency, tied to a financial indicator, reflecting their value in any kind of money, in various forms of capital and debt markets and also as a market signal.

In an embodiment, the invention, in its summing machine capacity, may also sum numerical figures expressed in any currency, such as dollars, yen or euros.

In a method of this embodiment, PESTLE factors that can have currency values assigned to data and attributes may be calculated in order to support decision-making that requires understanding financial aspects of PESTLE factors. Since everything is expressed in a given currency, e.g. US dollars, there is no need for the normalization step as everything is pre-normalized into US dollars. For exemplary purposes only and without limitation, such value summing may apply to ecological economic calculations, social economic calculations, technology economic calculations and the like.

In a method of this embodiment, so called “externality” accounting (PESTLE accounting that does not appear on traditional balance sheets) may be leveraged to determine without limitation and for exemplary purposes only “true cost” (e.g. the true cost of oil includes pollution, which can be quantified) and “true value” (e.g. the true value of a rainforest includes water management services, which can be quantified)

In yet another embodiment, the invention may be used to determine the value of the invention itself with respect to its ability to support universal sustainability in a given context and such value determination may be perpetual and dynamic.

In a method of this embodiment, this value may be expressed in the form of money, currency, financial considerations.

In another method of this embodiment, this value may be expressed in points, rankings or scores.

Yet another key feature and advantage of the above currency embodiment is the ability for communities defined by, for exemplary purposes only and without limitation, geography, affiliation, sector, to develop their own value indices and exchanges between one another, tied to a common value underlyer of universal sustainability.

In an embodiment, employment of certain forms of so-called “business intelligence” processes, including, for exemplary purposes only, text analytics, to analyze data sets (from blogs, articles, postings, etc.) will be employed for the purpose of processing all captured and contributed data into the weightings and appropriate other inputs, to be processed by an algorithm on an automatic, dynamic basis.

In yet another embodiment of the invention, a voting currency may be employed to complement the data obtained for various purposes, including, for exemplary purposes only, sentiment weighting and to close down uncertainty in raw data, hence a proxy for the so-called “wisdom of crowds.”

An embodiment of the invention is to output an internet based so-called “widget” that is disseminated in order to collect responses from community members, which will in turn drive data and weightings that enable a unified score for a given subject.

Another core function and embodiment of the invention is the collecting of intangibles and sentiment data such as, for exemplary purposes only, values, predictions, ideals, opinions or sentiments, as expressed numerically, regarding a given agenda statement or subject attribute weighting applying to the taxonomy of sustainability.

In yet another method of this embodiment, a viral Internet “widget”, may be disseminated to partner and member organizations to run on their own Internet web sites and collect data and other inputs thereon.

A feature and advantage of this method of the embodiment is that partner and member organizations displaying the widget on their Internet web sites can tap the input of their members and therefore contribute to the collaborative community on a remote basis.

Still another feature and advantage is the system enables users to set dynamic boundaries (infinitely expandable or contractible) on the scope of what is being measured.

Still another feature and advantage of the system is that this weighted normalized data system also means that experts have unlimited ability for recycling and re-using all the data, weights and ranges; data that has previously been submitted to the taxonomy for one subject can be reused by linking it to another, meaning that experts do not have to start from scratch when creating the boundaries of the subject they wish to score.

In another embodiment, the invention lends itself to so-called “enterprise software” or “software as a service.” In this embodiment, certain subjects, for exemplary purposes only, corporations and governments, will be able to run separate and private analyses of sensitivity testing for different sustainability initiatives, without limitation, products, services and policies, under the assumptions of unified and/or universal sustainability community standards or internally or otherwise defined standards. The software will be connected via a computer system to the main body of data in the invention, yet also have private, entity-controlled, access and information privileges and special tools designed to assist development of internal and external initiatives that support the mission of the entity and as they are aligned with universal sustainability in a given context.

In another embodiment, the invention allows the ability of users to rate the scores themselves, and by doing so account for the relative weight of attributes, the number of attributes with values attached to them, and the reliability of the source data and workflows that informed the values.

In a method of this embodiment, the system would notify users when there was missing data, and would set up an automatic trigger to prompt the completion of that missing data, helping the system to populate more rapidly.

A key feature and advantage of this embodiment is the data aggregation feature will, drive greater confidence in the score; the more data and the more certain the community is of that data's origins, the more the score becomes a meaningful indicator.

In an embodiment, the invention has the ability to populate the system rapidly and efficiently because it is designed with a high degree of reusability so that participants may leverage each other's data, decisions, measurements, questions, taxonomies and other findings—and be able to apply open and community data to their own unique purpose.

In a method of this embodiment, the invention can re-use raw input numerical data, which means users can re-contextualize existing data against new attributes, assigning new ranges or linking raw data to new attributes.

In a method of the embodiment, the invention can re-use subject taxonomies where users can drag, drop and edit and link to attributes, weights and community-set, situation-specific ranges or use any part of the subject taxonomy for their own custom purposes.

In a method of the embodiment, the invention can re-use Agenda taxonomies where users can drag, drop and edit statements and entire agenda taxonomy branches and customize for their own purposes.

In a method of the embodiment, the invention can re-use scores; calculations can be re-purposed at any point in the system, in which case a subject score at a lower level can be used to help determine a subject score at a higher level. For exemplary purposes only and without limitation, a score on car batteries could be re-used in the score for a car.

Still yet another key feature and advantage of the invention is enabling intelligent market design based upon community measurement of unified sustainability.

In a method of the embodiment, commercial or charitable activity tied to this indicator may measure results in financial or social gain, on a unified and harmonized value basis in turn having sustainability as an underlyer.

In a further embodiment, the derived value may be transformed into natural capital vehicles, for exemplary purposes only and without limitation, a land, water or air trust.

In another embodiment, derived and recognized value may be leveraged to establish and build socially and environmentally beneficial institutions and projects, for exemplary purposes only and without limitation; renewable energy projects, water desalination projects, reforestation projects, all of which may be measured by the same process described in the invention.

In yet another embodiment, derived and recognized value may be leveraged towards socially desirable or preferable activities such as funding art, music, poetry, and other culture as deemed valuable by a society.

A key feature and advantage of the invention's production of an alphanumeric value indicator for universal sustainability is the use of said indicator in a plurality of commercial endeavors, for exemplary purposes only, new markets design and redesign of old markets.

In an embodiment, said indicator may be used as the basis for creation of a plurality of products and services on behalf of a plurality of entities, for exemplary purposes only, corporations and governments, in a plurality of industries, for exemplary purposes only, real estate development, energy and water.

In a method of the embodiment, subjects that reside within life cycle assessment of economic value chains, for exemplary purposes only, industrial, agricultural, manufacturing, service economic value chains may have their own sustainability value indicators, which contribute to a and measure the universal sustainable output of that economic value chain.

In a method of the value chain embodiment, the whole value chain model may be processed under a so-called ‘best of breed talent agency’ business process, which consists of steps (i) identifying qualified participants via the embodiment of the scoring protocol, yielding a unified sustainability value indicator for each qualified participant; (ii) auditing qualified participants to establish veracity of value indicator and claims; (iii) maintaining qualified participants in a computer database; (iv) selecting modular or whole value chain measurements for a given subject, for exemplary purposes only, a corporation, government or geographical region against a given project or development (for exemplary purposes only and without limitation, energy, water, land), whose goal is to achieve a similarly high score or rating (v) enabling a bidding process by qualified participants on the project or development; (vi) selecting and contracting with the winning qualified participant for performance of the project or development; (vii) managing the development, operations and monitoring of the project or development (viii) collecting a fee for service

In an embodiment, the invention may be paired with artificial intelligence properties or partnerships that endeavor to harmonize and optimize various aspects of the unified sustainability measurement effort, including, without limitation, the identification of patterns in voting; further optimization of expert and non-expert opinion; database operations and functionality of the same, calibration of evolving goals and objectives, baselines, thresholds and timelines, including progress in a plurality of components that govern voting or measurement, the processing of both sentiment and raw data, and other tasks and responsibilities as may inform the general principles, practices, objectives and efforts of the community.

In an embodiment, the invention facilitates a quantized hierarchy, capable of scoring subjects relative to universal sustainability and hence providing the basis for informed decision making.

In a method of this embodiment, said quantized hierarchy process may be employed to offer predictive results against universal sustainability and hence providing the basis for informed decision making.

In another method of this embodiment, the invention lends itself to modeling, whereby the scoring mechanism and the predictive mechanism are combined into a system that drives a critical path towards universal sustainability and therefore provides the basis for informed decision making.

In the preferred embodiment, the present invention utilizes a combination of; a agenda taxonomy of statements related to universal sustainability; a subject and attributes thereof for which aspects of the taxonomy apply; a universal sustainability value indicator of the subject against the taxonomy; an ability to filter particular aspects of the said value indicator through a custom view, for exemplary purposes only, any aspect or combination of PESTLE; branch of a taxonomy; a set of mathematical formulas or algorithms providing the calculation mechanism.

The taxonomy is designed as follows: at the highest order of organization lies universal sustainability, and below that level, related tiers with a plurality of statements outlining ideal outcomes of PESTLE factors that serve a plurality of fields of interest, and beneath that in the taxonomy, related tiers with a plurality of statements describing best practices of governance to serve said ideal outcomes. Within any order of statements there may be a taxonomy of sub-statements which increase in granularity at each successive lower sub-order within the entire taxonomy. The online community will augment a pre-populated taxonomy described as such.

From a technological standpoint, the modules of this taxonomy, subject selection, calculation and views enable the community to build the subject taxonomy and its various attributes and sub-attributes with a minimum need for cross-expertise by any sub-community. For example, the community entering information about cars may be distinct from that of fuel or pollution, yet all communities contribute collaboratively to the same taxonomical structure. Cross-expertise review is recommended to ensure that data submitted by experts falls in the right taxonomy tier, however the data itself does not require this. Upon reaching a functional threshold of taxonomical completeness for a given subject, the invention enables an automatic calculation of the considerations within the attribute set based upon the values provided by each expert community.

Further, upon the entering of sentiment data with respect to the statement taxonomy by a general interest (non-expert) community, the attribute values are given weights or relative importance by the sentiment data, so that a universal sustainability value indicator adjusted for general interest sentiment may be enabled.

In order to serve fair consensus, the invention enables a voting currency. In this case, participants with greater knowledge or understanding of the subject matter may be entitled to a greater value and hence heavier weight on their input. Alternately they may submit to a knowledge test to rank their level of knowledge against which voting weight may apply. Participant input is managed primarily by community members, via best web practices. Participant value may also be awarded based on other contributions to the community besides knowledge and understanding.

The process begins with a pre-populated set of statements under an agenda taxonomy relating to universal sustainability. Experts contribute data to the taxonomy, including taxonomical data and measurements and metrics and social voting, for exemplary purposes only and without limitation, in the case of imputing missing or conflicting data, harmonizing ratio and interval scales, weighting, range setting, dispute settlement and other efforts.

Experts contribute data and/or hold votes on, for exemplary purposes only and without limitation; which attributes (collectively an “attribute set”) are relevant for a given subject; weighting ascribed to importance a given individual attribute within an attribute set for a given subject; question/answer mapping for attributes, sets thereof, or subjects; definition of child attributes (sub-attributes) for a given parent (super-set of attributes); polarity normalization for attributes, i.e. whether the metric has a positive or negative impact against a given PESTLE factor; relative importance of attribute sets within its family of attribute sets (including parent, child and sibling attributes) for a given subject; ranges of a given attribute, e.g. high and low numbers, which in turn normalize values for a given subject.

The result of such process by experts with respect to subject attributes is that a plurality of data sets thereof may be harmonized, normalized and reused against one another, yielding equivalent relative and absolute universal sustainability indicator valuations against a plurality of like or unlike subjects and perpetual re-use of input data and output scores for additional measurements of sustainability.

In the preferred embodiment, data inputs on subject attributes are based on facts and/or validated assumptions, or else by expert consensus and intend to represent the best a community knows at a particular point in time.

While the invention is designed to hold space and be open to input of any and all sentiment, beliefs, opinions, subjective determinations, etc., the preferred embodiment is to limit such non-objective input in place of fact-based objective reasoning with full validation of any and all assumptions which may belie any subjective beliefs and therefore constitute preferable inputs.

With respect to attributes, non-objective inputs may be required when there is limited time, however, the invention has a bias toward fact-based rationality, pure logic and objective information especially as relates to harmonizing with the laws of physics and biology.

With respect to statements, however, in some cases, a community may know how to serve an agenda and in some cases it may not. For example, it may not be known what is the best way to deliver water to a population and opinions may abound within a community; in this case, subjective opinions may be input as statements fairly voted and weighted by the community; and objective data in the form of subject attributes may be calculated against those statements.

In a method of this embodiment, the invention may assign a relative importance or weight to a given statement (or child, parent or sibling thereof) within the taxonomy. For example, a community member may give greater weight to environmental statements as opposed to social statements, or any combination thereof. The process also provides a key differentiator to other systems or prior art; the formal and express introduction of alternative values, without limitation and for exemplary purposes only, social values, environmental values; into the calculation of traditionally measured economic value.

Other methods of obtaining intangibles or sentiment data may also occur in different ways; for exemplary purposes only and without limitation, through computer-generated search modules that parse natural language in text, audio or video and make determinations of positive or negative sentiment for a given subject. The data may then be utilized as a relative importance/weight indicator on statements in an agenda taxonomy, or if necessary, attributes of a subject taxonomy, where said weightings may depend on such data or where it is not possible to come to objective conclusions.

The system calculation proceeds from the aforementioned foundation; experts set ranges on a given attribute of a given subject and these are normalized into a 1000 point scale; experts weight attributes of subjects for importance; experts set polarities of a given range, positive or negative and the normalized value is adjusted based on the attribute's polarity; all adjusted sibling values are weighted as a percentage; weighted sibling values are summed to create the weighted total for the siblings' parent; said parents are ‘rolled up’ to their respective parent set (if any), and so on, for as many successive higher order parent sets (and siblings thereof) as the subject has until a final weighted total value for a given subject has been reached against a top level agenda or any successive statement branch in the agenda taxonomy.

Prior, all subject attributes are “linked” to their corresponding relevant agenda statements in the universal sustainability agendum taxonomy. This process puts each attribute of a subject in any given context and relationship to the agenda statement taxonomy and in so doing, enables inherent context-based meaning in the resulting calculation.

Concurrent to this process for attributes, all adjusted statements under the agenda statement taxonomy (parents, children, siblings) are weighted as a percentage based on the participant input and value. All weighted sub-statement values are summed to create the weighted total for the sibling's sub-statement parent; siblings' sub-statement parents ‘roll up’ to their respective parent set (if any) as an “adjusted value” and so on, as described above for attributes, for as many sub-statement sets as the parent statement has until a final weighted total value for a given statement branch or the top level agenda itself has been reached.

The result of said calculation methodology is the universal sustainability value indicator for a subject against universal sustainability in a given context.

Scoring may take place in one of three ways; by a) only scoring subjects against each other with no link to agenda statement taxonomy b) scoring subjects against the agenda statement taxonomy by looking at relevant links as described above c) scoring subjects against the entire agenda statement taxonomy, including both relevant links as well as all other statements (non-relevant). The latter is referred to as “zero-based cross normalization” (ZBCN). The result is three different types of scores with different uses; a) subject scores can be used to compare one similar subject against another b) so called “impact” scores can be used to rate a subject against its impact upon relevant factors in the agenda statement taxonomy as a whole or any given branch or part of it (e.g. may be related against a taxonomy that includes a city, but also against a particular neighborhood in that same city) c) so called ZBCN or “holistic” score which rates the subject against all considerations.

If a statement becomes null in the system through voting or non-applicability to subject, the statement or child thereof is ‘zero-based cross normalized’, meaning all statements are taken into account for every subject, but the ones that do not apply to a given subject are given a zero value in order to normalize across subjects. This zero-based cross normalization offers a different view and different decision-making strategy, in that all the factors may be considered, whether they are relevant or not to the subject. This solves problems such as “good in its class but poor overall against agenda” for exemplary purposes only, a “good” oil company.

The key to the data normalization process is the setting of ranges and polarity. With respect to polarity, in some cases, high numbers are good, in other cases, high numbers are bad. With respect to range setting, in some cases, a data input of 400 for example might be good, and in other cases, a data input of 400 might be bad. Range setting controls for this and with polarization, everything can be put on a 1-1000 point scale so the data is readily translatable and adjusted.

### DESCRIPTION OF THE INVENTION

### Example

The example following concerns the “Subject” of a large solar photovoltaic electrical project in a local geographic community whose primary default source of electric energy is coal.

A top-level agenda might be stated as: “SUFFICIENT, SAFE CLEAN ENERGY FOR OUR COMMUNITY”. Statements within the agenda taxonomy that might apply to this agenda could include; “improve energy efficiency”, “improve local control”, “improve energy security”, “promote technological development”, “stimulate ‘green jobs’”, “protect the local environment”, “protect local species”, “reduce airborne toxins”, “reduce health impacts”, “reduce water contamination”, “avoid future costs of carbon regulation”, “avoid volatility of commodity energy prices” or “avoid pollution cleanup costs”. These are taxonomized in the form of “in order to X, we need to Y”, or “in order to avoid pollution cleanup costs, we need to reduce pollution”; in this case, reduce pollution is a child statement to avoid pollution cleanup costs.

The subject to be measured is the solar photovoltaic plant, and the community must list attributes of the plant, both positive and negative in a form that will elicit numerical data that can be calculated. These attributes might be specific to the solar plant itself, “environmental impact of materials”, “toxic materials reclamation”, “solar panel efficiency”, “land footprint” and so forth. In addition, attributes could be based on the value that the solar project brings to the community: “number of new jobs created”, “amount of energy purchased locally”, “number of local students trained in solar technology”, “number of species saved”, “health care cost savings”, “toxic emissions reduced”. In the case of “toxic emissions reduced”, the community can list sub-attributes of particular diseases from particular toxins (“CO2”, “NOx”, “SO2”, “particulate matter”, all siblings of parent “toxic emissions”.

Experts decide which attributes belong in a given attribute set.

Experts determine ranges, such as “particulate matter 1-100” or “land footprint 10 to 10,000 acres”—and these are normalized to a 1000 point scale.

Experts determine polarity—“land footprint” and “particulate matter” is negative, while “job creation” is positive.

Experts also determine relative weight and importance; if the coal plant is in an unpopulated area, land acreage may have a lower relative weighting. Relative importance is determined via expert opinion or via voting process described above.

This process normalizes values for attributes of the subject “photovoltaic electric solar project.”

In a parallel process, community participants provide weighting input on the statements such as “reduce water stress”, “increase energy security” and “reduce air pollution” through a voting process. A voter might choose to allocate 60% of his or her 100 units for a given tier to “water stress”, 30% to “air pollution” and 10% to “energy security” or any combination thereof, while another community member may do the reverse.

Once these are selected, numerical input data must be entered on each of these attributes so they may be normalized.

With all attributes and statements weighted in their respective taxonomies and all data normalized, the next step is to link each attribute to their relevant and applicable statements on the agenda taxonomy. For example, “health care cost savings” attribute could be linked to “reduce health care impacts” statement.

The calculation proceeds; siblings attributes such as “levels of NOx”, “levels of CO2”, “levels of SO2” and “levels of particulate matter” are measured, polarity adjusted, ranges set, weighted for importance and put into the normalized value for the attribute set “toxins” and its respective parent set “health care impact”. In turn, siblings such as “environmental damage” and “acres of land preserved” go through the same process and are put into the normalized value for “environmental impact” (and other parents such as “species loss”).

Eventually, the process of normalization and weighting into adjusted values, and rolling up to higher parent attributes and statements, yields a single alphanumeric value indicator. At this point, one could compare, on a unified and normalized basis, the photovoltaic electric solar plant against the agenda of Sufficient, Safe, Clean Energy. It could also be compared to a rival photovoltaic electric plant being proposed to the same community. It could also be measured against any branch of the agenda taxonomy, such as “reduce pollution”, or alternatively, all considerations of the agenda, and thus demonstrate that it has a high enough score to be considered as an option in the first place.

Further, one could compare the social and environmental benefits of the photovoltaic plant against the technological and political benefits, or in any combination thereof. If public policy is held to account for the service of sustainability, then policy makers could model the effects of one type of technology against another, one type of incentive program against another, or simply what environment to site a power facility to minimize climate, social and environmental harm.

The result of said calculation methodology is the alphanumeric value indicator for a subject against the stated agenda.

Further, the invention enables the opportunity for modeling in part by reversing the taxonomy from a decision making tool to a predictive engine; combined becoming a tool with two aspects that drives a critical path towards an agenda.

### Example of Employment in Commerce:

Examples follow of how different industries might utilize various agendas and measure subjects;

Real estate; utilizing unified sustainability measurements and information services to enable local community real estate development. Agenda might be defined as zero energy and waste built environment. Statements relating to the agenda may be: so-called LEED certified building architecture, sensitive land protection, labor conditions, social and environmental outputs, efficient use of land and building spaces. Subjects might include a particular building with attributes including, waste and recycling programs, rooftop gardens, water filtration, reclamation and conservation programs, natural lighting strategies, energy use and so forth. Calculations could be used to demonstrate impact of a building on an urban landscape defined by service to the given agenda.

Energy; utilizing unified sustainability measurements and information services to enable the energy needs of any segment of commerce or regional functionality, including scoring subjects such as fossil based transport or generation fuels, solar thermal or photovoltaic energy, wind power, crop-based fuels, ocean and tide power, algae-based fuels, hydrogen, landfill gas, and water-based fuels technology all against an agenda of “abundant and clean energy for all needs”.

Water; utilizing unified sustainability measurements and information services to enable the energy needs of any segment of commerce or regional functionality, including subjects relating to: desalination, filtration, capture and delivery, and reprocessing of water and other technologies, against an agenda of “clean, safe and abundant water for all life in X region”.

The employment of said alphanumeric value indicator for a unified sustainability measurement in above examples of commerce may be the basis of new markets design.

The result of a new market design is the context for new financial valuations and capital pricing and vice versa.

The results of a new market design are the context for new policy initiatives and vice versa.

New valuations give rise to the potential for alternative currency in a plurality of embodiments as well as the re-pricing of assets in existing currencies.

The premises and governing dynamics of PESTLE factors are altered in ways that positively impact and provide potential for reaching unified sustainability for greater numbers of humans and non-humans.

### GLOSSARY

### Agendum

In this description, the word “Agendum” is a single item of an agenda. An agenda is a list of items. Accordingly, agendum refers to a single goal or objective at the top of a statement taxonomy. For example, an agendum could be:

“Create a universal global sustainability”

### Statement

In this description, the word “Statement(s)” refers to one or more declarative sentences which are organized hierarchically under the Agendum and which are meant to support the Agendum itself. For example, a Statement would be “Create climate balance”

### Parent Statement

In this description, the words “Parent Statement(s)” refers to a declarative sentence that begets other declarative sentences which are organized hierarchically under the Agendum Statement and which are meant to support the Agendum itself. A Parent Statement would be:

“Create climate balance”

### Child Statement

In this description, the words “Child Statement(s)” refers to a declarative sentence that is preceded hierarchically by a Parent Statement, which is meant to be supported by the Child Statement(s).

For example, where the Parent Statement is “Create climate balance”
a Child Statement would be:
“Eliminate the harmful effects of air pollution”

### Sibling Statement

In this description, the words “Sibling Statement” refers to a declarative sentence that refers to one of two or more declarative sentences sharing at least one common Parent Statement. This group of Statements is also referred to as a “Peer Group”.

Where a Parent Statement is “Create climate balance”
Sibling Statements would be:
“Eliminate the effects of air pollution”
“Eliminate the effects of water pollution”

### Agenda Statement Taxonomy

In this description, the words “Statement Taxonomy” or “Agenda Statement Taxonomy” or “Agenda Taxonomy”, refer to the relational hierarchy of Statements which are descendants to the single Agendum at the top of the hierarchy.

1. “Create a universal global sustainability”
a. “Create climate balance”
   i. “Eliminate the effects of air pollution”
   ii. “Eliminate the effects of water pollution”

### Subject

In this description, the word “Subject” is a generic reference to a person, place or thing for which a Score can be calculated. It is often used interchangeably with Subject Instance. An example of a subject could be a farm, a car, a person, or a corporation.

### Subject Type

In this description, the word, “Subject Type” is a category of person, place or thing for which a Score can be calculated. Examples of a Subject Type include “farm” “car”, “building”, “employee”

### Subject Instance

In this description, the word, “Subject Instance” is the manifestation of a Subject Type.

A subject Instance of the Subject Type “farm” is a grape vineyard in France.
A Subject Instance of the Subject Type “car” is a vehicle with a specific VIN.
A Subject Instance of the Subject Type “building” is a building with an address.
Subject is often used interchangeably with Subject Instance.

### Attribute

In this description, the words “Attribute” is a description of a data point that will be collected for Subject Instance. Attributes are defined for Subject Types. Attributes consist of a description of the data point being collected/measured, and a process to normalize the actual input into a value which can be combined and/or used in conjunction with the input collected for other Attributes. Attributes collect data by way of questions that elicit the data.

For example, where the subject type is “soil impact” an Attribute would be “how many lbs of nitrogen per hectare” and hence elicit a numerical data input.

### Attribute Value

In this description, the words “Attribute Value” are the collected/measured value for a specific Subject Instance for a specific Attribute. It is also the “Data Input” or “Numerical Data Input”. It is this value that will be put through the Attribute's process of normalization allowing it to be combined and/or used in conjunction with other Attribute Values.

Where the Attribute is “Pounds of Nitrogen per hectare,” The Attribute value would be the answer, for example “2 Lbs per hectare.”

### Parent and Child Attributes/Values

In this description, the words “Parent Attribute(s)” refers to an Attribute that begets other (Child) Attributes which are organized hierarchically under the Parent Attribute and which are meant to support the Parent Attribute itself. For example, we could ask questions about the 2 lbs of nitrogen—where did the nitrogen come from? This would make for nested questions/data points and attributes/values.

### Attribute Set

In this description, the words “Attribute Set”, “Attribute Group”, “Sibling Attributes” refers to a group of two or more Attributes sharing at least one common Parent Attribute. This group of Attributes is also referred to as a “Peer Group”. Where the Parent Attribute is “Fertilizer in use” and Attribute set would include “What type,” “How much,” and “How often”
Fertilizer in use
   What type
      How much
      How often

### Basic Subject Score

Basic Subject Score is calculated by summing the weighted, normalized data values of the questions only. Considers all known subject attributes. Magnifies similarities, differences and focuses on attributes and weightings, no link to statements. In the case we do not necessarily care about the overall agenda, but are concerned with obtaining a wide and dynamic measurement scope. Used to compare subjects that are similar—this similarity, combined with normalization and weighting of the questions preserves the meaning and the relationships of the data.

### Impact Score

Measures the impact of the subject on the agenda. Takes into account the links between the subject and agenda taxonomies. The subject is scored based on its how its attribute values influence its related statements. Does not calculate statements that attributes do not link to.

Drives insights about the Subject against the Agenda and therefore compares similar or dissimilar Subjects. Measurement in context; the process of articulating each statement and goal. Aligns with agenda. Enables specific view on specific branch of agenda. Explicit results with meaning baked into the score clarifies communication because contexts are explicit.

One subject could have two impact scores, for example—one for the top level agenda and one for a sub agenda under the same taxonomy.

### Holistic Score (Zero Based Cross Normalized or ZBCN Score)

Mathematically, the Holistic Score is just like the Impact Score except that ALL Statements are considered. Statements that are not directly linked to Attributes are given a neutral value and normalized.

The insertion of neutral values will tend to dilute the numbers and hence drive the score towards the middle of the system's scale, in this case towards a score of 500.

Scores greater than 500 mean the subject is relevant to and has a positive contribution towards fulfilling the top-level Agenda. Scores under 500 mean that the subject is of less relevance to and possibly detracts from the Agenda.

Measures subject performance on the big picture, considers everything in the agenda taxonomy, rates overall importance of the Subject itself in relation to all other considerations within the taxonomy; whether or not the Questions and Statements are linked, addresses problem of good in its class but bad overall. Provides relative importance to the agenda; those subjects that score best against the agenda indicate if subject is worth further consideration or resources. If score is low, may not contribute much to overall Agenda. If score of related class of subjects is low, may indicate that class does not merit resources to measure.

Streamlines what is important against agenda for better decision-making.

### Weighting

In this description, the words “weighting” or “weighted in relation to” refers to the process by which Sibling Statements are valued in relation to one another indicating how they contribute to the definition and ultimate Score of their Parent Statement.

For example, a Parent Statement
“We must create climate balance” has 3 Child Statements; their weighting is shown below:
   We must improve air quality—weight=40%
   We must improve water quality—weight=25%
   We must improve soil quality—weight=35%

In the example above we are saying that the Air Quality Child Statement has the highest contribution on the value of the Create Climate Balance Parent Statement with the Biodiversity and Water Quality Child Statements having a lesser contribution.

Statements are always weighted in consideration of their Parent Statement.

### Universal Sustainability

Ideal balance of PESTLE factors in any given context (i.e. local, regional, global, organization-wide, etc.) serving the highest quality of life for all life within said context.

Accordingly, a feature and advantage of the preferred embodiment is its ability to create a unified measurement for a set of governing dynamics, which informs policy, creates a common basis for value, both in rank and monetary terms, helps design marketplace behavior, re-price capital, enable creation of ranking and monetary valuation, enable alternative currency and attendant incentive/reward systems and creates multiple indexes in given subjects.

Another feature and advantage of the present invention is its ability to improve PESTLE factors on a plurality of levels worldwide.

Still another feature and advantage of the present invention is its ability to be entirely coherent with emerging trends in the networked economies of the future, such as mass decentralization of information and energy, global awareness of problems and solutions reaching critical mass, so-called “petabyte age” information processing capabilities, emergence of interest in so-called “triple bottom line” investing (economic, social and environmental results) and the emergence of a fully information-empowered global citizenry, portend massive changes in the existing paradigm. It is with these trends as backdrop that the invention may enable this emergent global society to transition from a scarcity-based future based upon competitive quest for dominate power to one of a shared and abundant future based upon a cooperative quest for generative power.

Yet another feature and advantage of the present invention is its ability to utilize the networked economy to harness collective judgment with respect to PESTLE considerations, with subjective and objective inputs.

A further feature and advantage of the present invention is its ability to have the effect of transforming universal sustainability data into indicators and indices that in turn create the basis for a wide number of embodiments including marketplace design, public policy, capital re-pricing, alternative currency systems, common value basis and simulation of capital and currency regimes against such basis.

These and other features and advantages of the present invention will become more apparent to one skilled in the art from the following description and claims when read in light of the accompanying drawings.

### BRIEF DESCRIPTION OF THE SEVERAL VIEWS OF THE DRAWINGS

The present invention will be better understood by reading the Detailed Description of the Preferred Embodiments with reference to the accompanying drawing figures, in which like reference numerals denote similar structure and refer to like elements throughout, and in which:

FIG. 1 is a flowchart illustrating a method for computing a universal sustainability score according to a preferred embodiment;

FIG. 2 is a spreadsheet illustrating attributes and components according to a preferred embodiment;

FIG. 3 is a spreadsheet illustrating sub-statements with corresponding sub-statement weighted values calculated into sub-statement weighted totals according to a preferred embodiment;

FIG. 4 is a spreadsheet illustrating statement weighted values for corresponding statements calculated into statement weighted totals according to a preferred embodiment;

FIG. 5 is a spreadsheet illustrating agendum weighted values for corresponding agenda calculated into a Universal Sustainability Score according to a preferred embodiment;

FIG. 6 is a flowchart illustrating a method to derive attribute weighted total for attributes according to a preferred embodiment;

FIG. 7 is a flowchart illustrating steps utilized to derive a Universal Sustainability Score according to a preferred embodiment;

FIG. 8 illustrates the components of a server utilized for obtaining a Universal Sustainability Score according to the preferred embodiment;

FIG. 9 illustrates PESTLE factors associated with computing a universal sustainability score according to the preferred embodiment;

FIG. 10 is a flowchart illustrating steps utilized to derive an impact score for a subject relative to statements according to the preferred embodiment; and

FIG. 11 is a flowchart illustrating steps utilized to derive a subject score for a subject according to the preferred embodiment.

### DETAILED DESCRIPTION OF THE PREFERRED EMBODIMENTS OF THE INVENTION

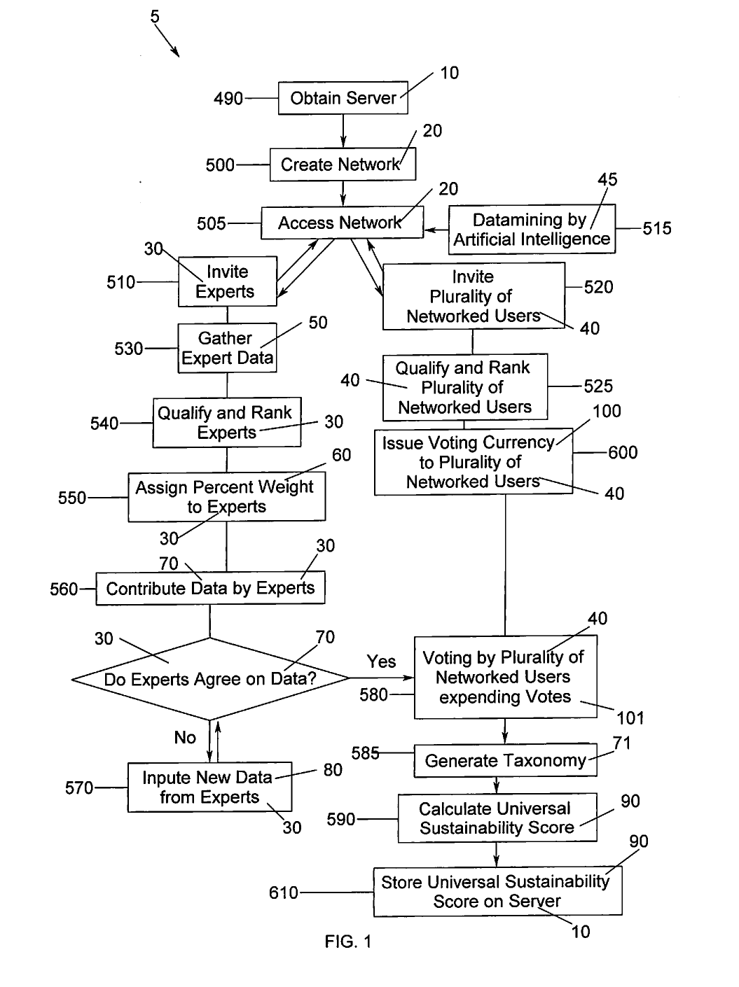

In describing the preferred embodiments of the present invention, as illustrated in FIGS. 1-11, specific terminology is employed for the sake of clarity. The invention, however, is not intended to be limited to the specific terminology so selected, and it is to be understood that each specific element includes all technical equivalents that operate in a similar manner to accomplish similar functions.

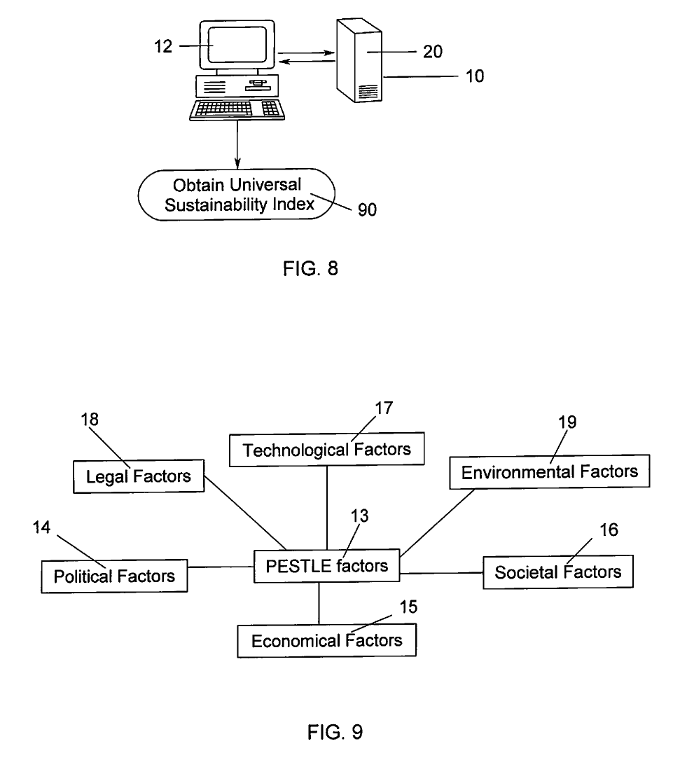

Referring now to FIGS. 1 and 8, process 5 for computing Universal Sustainability Score 90 comprises obtaining server 10 via step 490, wherein server 10 comprises network 20 created via step 500, and wherein network 20 is accessed via step 505 through server 10 via computer 12. Experts 30 are invited via step 510 to join network 20, wherein experts 30 comprise individuals that are skilled in a particular field. Additionally, plurality of networked users 40 are invited via step 520 to join network 20, wherein plurality of networked users 40 are participating individuals, and wherein plurality of networked users 40 may comprise experts 30, and wherein plurality of networked users 40 are invited to participate in network 20 via, for exemplary purposes only, a website having a widget (object which allows user interaction), emails, social networks (such as, FACEBOOK and MYSPACE), and the like. Plurality of networked users 40 are qualified and ranked via step 525 using surveying and testing methods, and the like, and whereby they are subsequently issued voting currency 100 via step 600. Voting currency 100 allows plurality of networked users 40 to expend a certain quantity of voting currency 100 to weight choices or options. Plurality of networked users 40 may also issue votes 101 towards a particular choice or option, wherein votes 101 are utilized to systematically adjust facets within process 5. Network 20 further comprises artificial intelligence 45, wherein artificial intelligence 45 datamines, via step 515, from websites outside the network 20.

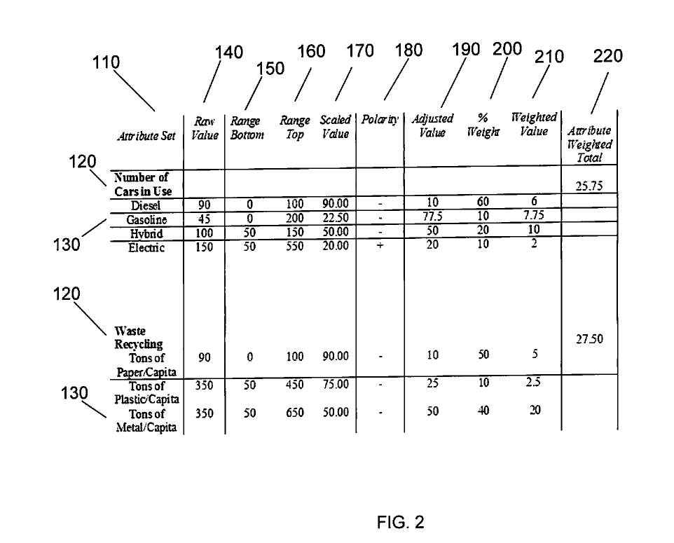

Still referring to FIG. 1, expert data 50 is gathered via step 530 from experts 30, wherein expert data 50 comprises, for exemplary purposes only, the educational background and/or other information to determine the expertise of experts 30. Expert data 50 is incorporated into surveying and testing methods, and the like, to qualify and rank experts 30 via step 540. Experts 30 are then assigned percent weight 60 via step 550, wherein percent weight 60 is a reflection of expert 30's expertise in a particular field. Subsequently, experts 30 contribute and vote on data 70 via step 560, wherein data 70 comprises, as discussed hereinbelow in FIGS. 2-5, attributes 120, sub-attributes 130, sub-statements 230, statements 270, weightings 200, 240, 280, 330, and the like, and wherein data 70 is utilized to generate taxonomy 71, and wherein taxonomy 71 is a modular hierarchy of organized sub-attributes 130, attributes 120, sub-statements 230, and statements 270. If experts 30 disagree on data 70, then experts 30 continue to input new data 80 via step 570, wherein new data 80 comprises, for exemplary purposes only, new information, values, ranges, equations, and the like. If experts 30 agree on data 70 or agree on new data 80, then plurality of networked users 40 vote on data 70 and/or new data 80 via step 580. As shown in more detail in FIGS. 2-9, taxonomy 71 is generated via step 585, wherein Universal Sustainability Score 90 is subsequently calculated via step 590, and wherein Universal Sustainability Score 90 is based on a plurality of mathematical calculations as are shown herein via example, such as, for exemplary purposes only, addition and multiplication, and wherein Universal Sustainability Score is stored on server 10 via step 610 and may be selectively accessed via computer 12 (best shown in FIG. 8).

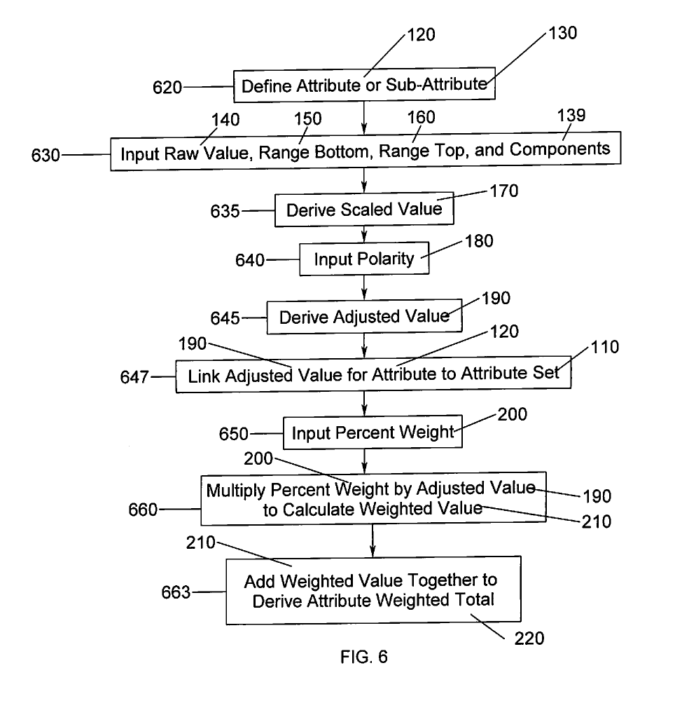

Referring to FIGS. 2 and 6, attribute set 110 comprises attributes 120, wherein attributes 120 comprise sub-attributes 130, and wherein attributes 120 and/or sub-attributes 130 are defined by experts 30 via step 620, and wherein attributes 120 comprise, for exemplary purposes only, a data point or an input, such as, for exemplary purpose only, and as shown in FIG. 2, the number of cars in use. Sub-attributes 130 are a collection of references relating to attributes 120, wherein sub-attributes 130 comprise, for exemplary purposes and as shown in FIG. 2, diesel cars, gasoline cars, hybrid cars and electric cars.

Still referring to FIGS. 2 and 6, for defined attributes 120 or sub-attributes 130, experts 30 may selectively input via step 630 a variety of components 139, such as, for exemplary purposes only and as shown in FIG. 2, raw value 140, range bottom 150 and range top 160 to obtain scaled value 170, wherein scaled value 170 is derived via step 635 by, for exemplary purposes only, linear, parabolic or logarithmic equations, to obtain a standardized value between zero and one hundred. It will be recognized by those skilled in the art that any range could be utilized. Raw value 140 is an assessment of attributes 120 and/or sub-attributes 130 by experts 30, wherein range bottom 150 and range top 160 are numerical scales for attributes 120 and/or sub-attributes 130. Experts 30 further input polarity 180 for attributes 120 and/or sub-attribute 130 via step 640, wherein polarity 180 describes whether attributes 120 and/or sub-attributes 130 negatively or positively affect, for exemplary purposes only, any input relating to PESTLE factors 13 (best shown in FIG. 9), wherein PESTLE factors 13 comprise political factors 14, economical factors 15, societal factors 16, technological factors 17, legal factors 18, and environmental factors 19. Scaled value 170 is adjusted via step 645 utilizing polarity 180 to obtain adjusted value 190. Attributes 120 and/or sub-attributes 130, along with corresponding adjusted values 190, are linked via step 647 by experts 30 to selected attribute set 110. Plurality of networked users 40 subsequently input via step 650 percent weight 200, wherein percent weight 200 is defined by means of expended voting currency 100 or casted votes 101, and wherein percent weight 200 is then mathematically applied via step 660, for exemplary purposes, utilizing multiplication, to adjusted value 190 to calculate weighted value 210 for attributes 120 and sub-attributes 130, and wherein weighted value 210 for attributes 120 and sub-attributes 130 linked together in attribute set 110 are added together via step 663 to derive attribute weighted total 220 for attributes 120.

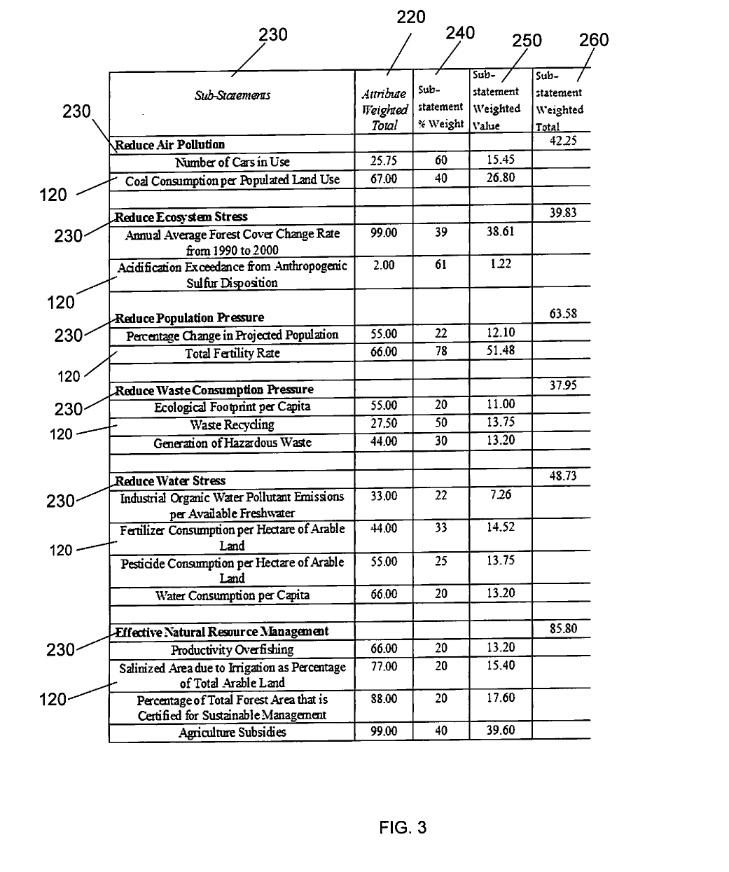

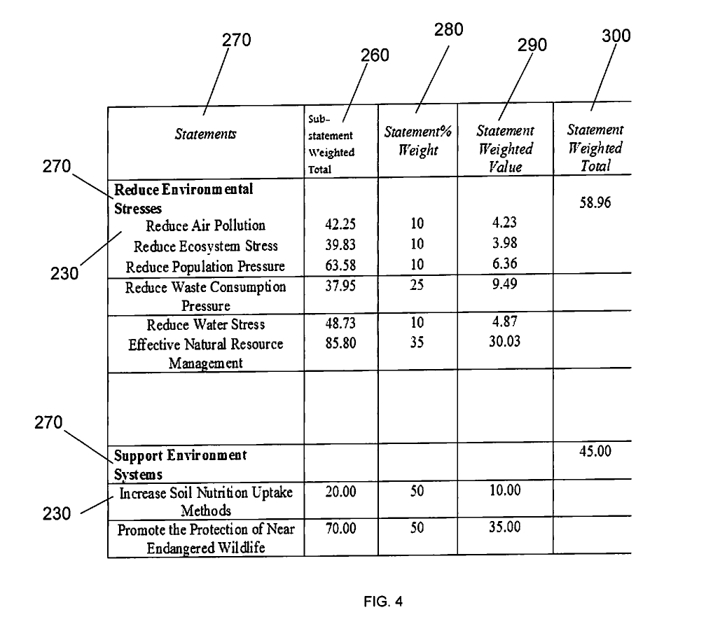

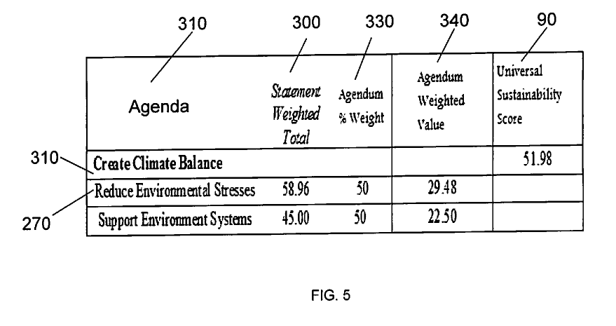

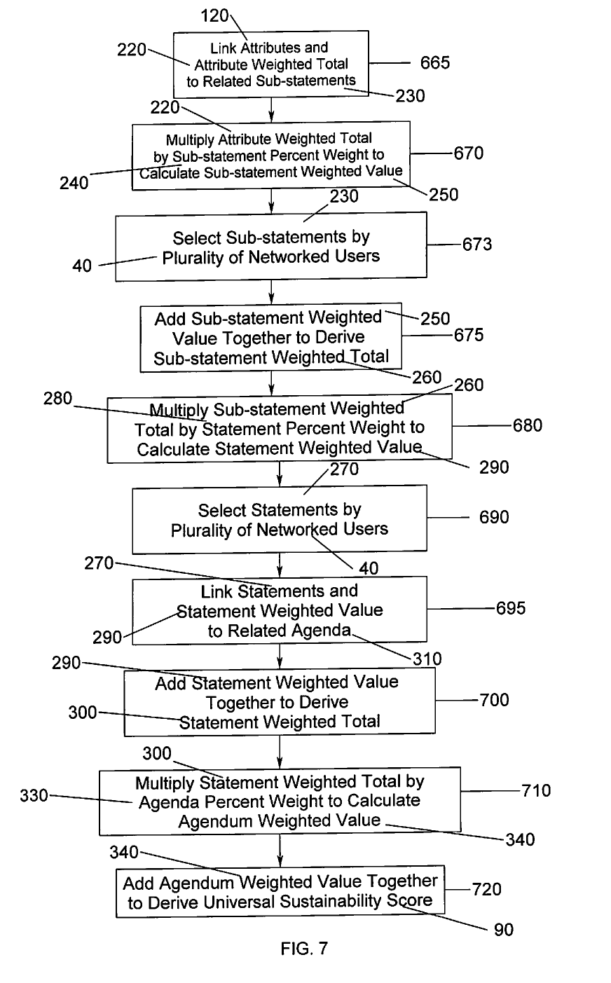

Referring now to FIGS. 3 and 7, plurality of networked users 40 choose via step 665 selected attributes 120 to affect selected sub-statements 230 within taxonomy 71, wherein sub-statements 230 inherit attribute weighted total 220 of chosen attributes 120. Consequently, attribute weighted total 220 is utilized in calculating sub-statement weighted value 250 for sub-statements 230, wherein attribute weighted total 220 of attributes 120 is mathematically applied, for exemplary purposes, utilizing multiplication, via step 670 to sub-statement percent weight 240, resulting in sub-statement weighted value 250 for sub-statement 230, wherein sub-statement percent weight 240 is defined by means of expended voting currency 100 or casted votes 101 by plurality of networked users 40. Plurality of networked users 40 choose via step 673 selected sub-statement 230 to affect statement 270 within taxonomy 71, wherein sub-statement weighted value 250 for corresponding sub-statement 230, along with other sub-statement weighted value 250 for differing sub-statement 230 linked to common statement 270, are mathematically combined via step 675 to derive sub-statement weighted total 260, and wherein statements 270 inherit sub-statement weighted total 260 of chosen sub-statements 230. Referring now to FIGS. 4 and 7, consequently, sub-statement weighted total 260 is utilized in calculating statement weighted value 290 for statements 270, wherein sub-statement weighted total 260 is mathematically applied, for exemplary purposes, utilizing multiplication, via step 680 to statement percent weight 280, resulting in statement weighted value 290 for statement 270, and wherein statements 270 relate to, for exemplary purposes only, PESTLE factors 13, and wherein statement percent weight 280 is defined by means of expended voting currency 100 or casted votes 101 by plurality of networked users 40. Plurality of networked users 40 choose via step 690 selected statement 270 to affect agenda 310 within taxonomy 71, wherein statement weighted value 290 for corresponding statement 270, along with other statement weighted value 290 for differing statement 270 linked via step 695 to common agenda 310, are mathematically combined via step 700 to derive statement weighted total 300, and wherein agenda 310 inherit statement weighted total 300 of chosen statements 270. Referring now to FIGS. 5 and 7, consequently, statement weighted total 300 is utilized in calculating agendum weighted value 340 for agenda 310, wherein statement weighted total 300 is mathematically applied, for exemplary purposes, utilizing multiplication, via step 710 to agenda percent weight 330, resulting in agendum weighted value 340 for agenda 310, and wherein agenda 310 relate to, for exemplary purposes only, PESTLE factors 13, and wherein agenda percent weight 310 is defined by means of expended voting currency 100 or casted votes 101 by plurality of networked users 40. It will be recognized by those skilled in the art that agendum weighted value 340 for agenda 310 may also be obtained from sub-statement weighted total 260 instead of statement weighted total 300, wherein plurality of networked users 40 choose selected sub-statement 230 to affect agenda 310 within taxonomy 71, and wherein sub-statement weighted total 260 is mathematically applied, for exemplary purposes only, utilizing multiplication, to agenda percent weight 330, resulting in agendum weighted value 340 for agenda 310. Plurality of networked users 40 selectively combine via step 720 agendum weighted value 340 of selected agenda 310 to mathematically derive Universal Sustainability Score 90, wherein agendum weighted value 340 are numerical values relating to universal sustainability.

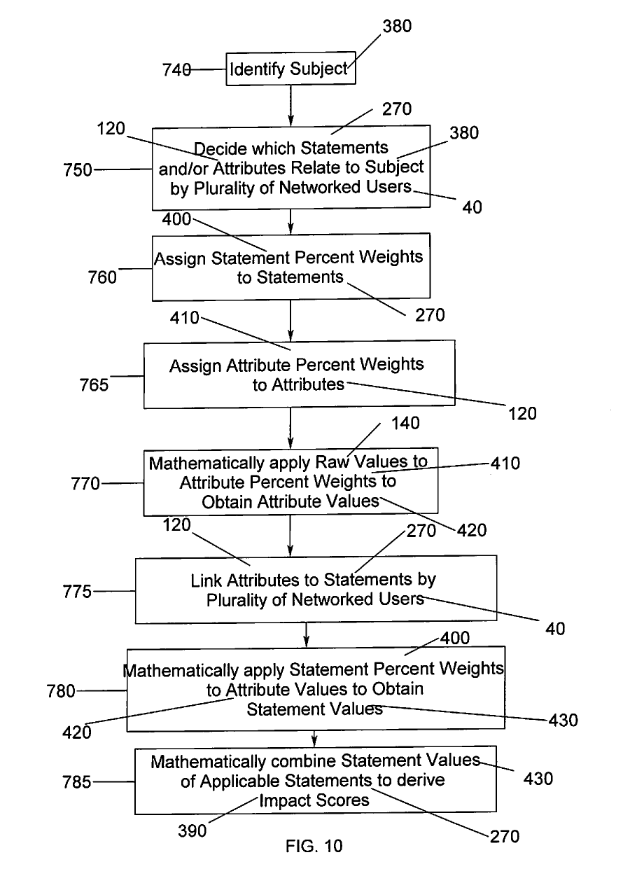

Referring now to FIG. 10, process 5 for computing universal sustainability score 90 may further be utilized to obtain impact scores 390, wherein impact scores 390 are an indicator of universal sustainability of subjects 380 relative to applicable statements 270, and wherein subjects 380 comprise for exemplary purposes only, a person, a place, a thing, and combinations thereof for which a numerical value may be calculated, and wherein subjects 380 are identified by plurality of networked users 40 via step 740. Plurality of networked users 40 may selectively utilize via step 750 statements 270, attributes 120, and combinations thereof generated from process 5, wherein experts 30 select which statements 270 and attributes 120 apply to subject 380. Statements 270 are assigned via step 760 statement percent weights 400. Attributes 120 are assigned via step 765 attribute percent weights 410. Subsequently, raw values 140, previously inputted into attributes 120 via process 5, are mathematically applied via step 770 to attribute percent weights 410 to derive attribute values 420. Concurrently, plurality of networked users 40 selectively link via step 775 attributes 120 to statements 270, wherein attribute values 420 of attributes 120 selectively linked to statements 270 are mathematically applied via step 780 to statement percent weights 400 to derive statement values 430. Statement values 430 of statements 270 deemed applicable to subject 380 are mathematically combined via step 785 to derive impact scores 390.

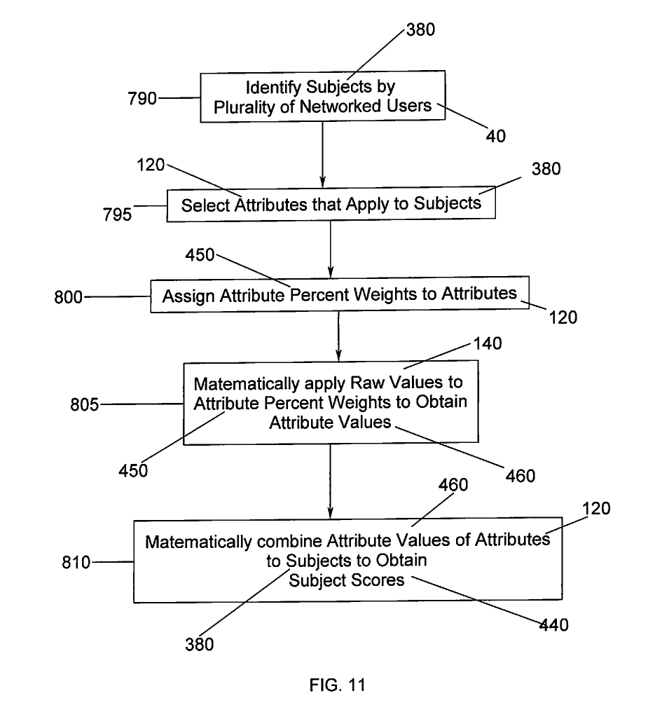

Referring now to FIG. 11, process 5 for computing universal sustainability score 90 may further be utilized to obtain subject scores 440, wherein subject scores 440 are a numerical value associated with subjects 380, and wherein subjects 380 comprise for exemplary purposes only, a person, a place, a thing, and combinations thereof. Subjects 380 are identified by plurality of networked users 40 via step 790. Plurality of networked users 40 selectively utilize via step 795 attributes 120 generated from process 5, wherein plurality of networked users 40 select attributes 120 to apply to subjects 380. Attributes 120 are assigned via step 800 attribute percent weights 450. Subsequently, raw values 140, previously inputted into attributes 120 via process 5, are mathematically applied to attribute percent weights 450 via step 805 to derive attribute values 460. Attribute values 460 of attributes 120 deemed applicable to subject 380 are mathematically combined via step 810 to derive subject scores 440.

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims.

What is claimed is:

1. A method for generating a universal sustainability score, said method comprising the steps of:
utilizing at least one computer processor to generate a taxonomy from data, wherein said data is selected from the group consisting of statements, subjects, attributes, and combinations thereof, and wherein said taxonomy supports an agendum;
assigning raw values to said attributes, wherein said raw values are a numerical assessment of said attributes;
normalizing said raw values into scaled values, wherein said scaled values are standardized raw values;
adjusting said scaled values into adjusted values, wherein said adjusted values indicate the polarity of said attributes;
weighting said adjusted values into weighted values, wherein percent weights are mathematically applied to said adjusted values to calculate said weighted values;
calculating said weighted values into statement weighted values, wherein said statement weighted values are mathematically derived throughout said taxonomy utilizing said weighted values linked to said statements, and wherein said statement weighted values are numerical values associated with said statements; and
calculating said statement weighted values into agendum weighted values, wherein said agendum weighted values are mathematically derived throughout said taxonomy utilizing said statement weighted values linked to said agendum, and wherein said agendum weighted values are numerical values associated with said agendum, and wherein said agendum weighted values are mathematically combined to generate said universal sustainability score.

2. The method of claim 1, wherein said data is contributed into said taxonomy by an entity selected from the group consisting of artificial intelligence, input data from a plurality of networked users, captured data from a plurality of data sources, and combinations thereof.

3. The method of claim 2, wherein said data is related to PESTLE factors, wherein said PESTLE factors are selected from the group consisting of political factors, economical factors, societal factors, technological factors, legal factors, environmental factors, and combinations thereof.

4. The method claim 3, wherein said plurality of networked users comprise individuals skilled in a particular field, and wherein said plurality of networked users accumulate voting currency.

5. The method of claim 4, wherein said step of assigning said raw values to said attributes further comprises the steps of:
assigning a range bottom to said attributes, wherein said range bottom is the lowest acceptable numeric value for said raw values, and wherein said plurality of networked users assign said range bottom to said attributes; and
assigning a range top to said attributes by said plurality of networked users, wherein said range top is the highest acceptable numeric value for said raw values, and wherein said plurality of networked users assign said range top to said attributes.

6. The method of claim 5, wherein said raw values are normalized on a numeric scale between said range bottom and said range top.

7. The method of claim 6, wherein said step of adjusting said scaled values into said adjusted values further comprises the step of:
assigning a polarity to said scaled values, wherein said polarity is chosen from the group consisting of negative polarity, positive polarity, and combinations thereof.

8. The method of claim 7, wherein said percent weights are defined by said plurality of networked users, and wherein said plurality of networked users directly input a numeric value for said percent weights.

9. The method of claim 8, wherein said percent weights are defined by said plurality of networked users, and wherein said plurality of networked users selectively expend voting currency to input a numeric value for said percent weights.

10. The method of claim 9, wherein said percent weights are defined by said plurality of networked users, and wherein said plurality of networked users selectively cast votes towards a numeric value to be inputted for said percent weights, and wherein said votes systematically adjust said percent weights.

11. The method of claim 10, wherein said universal sustainability score comprises a numerical value, and wherein said universal sustainability score is representative of PESTLE factors.

12. The method of claim 11, wherein said statements in said taxonomy further comprise sub-statements, and wherein said statements support said agenda, and wherein said statements are organized hierarchically under said agenda.

13. The method of claim 12, wherein said subjects are selected from the group consisting of a person, a place, a thing, and combinations thereof, and wherein said universal sustainability score is calculated for said subjects.

14. The method of claim 13, wherein said attributes in said taxonomy further comprise sub-attributes, wherein said sub-attributes sharing common said attributes are linked together into attribute sets, and wherein said attribute sets produce unified said weighted values for said attributes.

15. The method of claim 14, wherein said attributes are selectively linked to said statements, and wherein said weighted values for said attributes are mathematically applied to said percent weights of linked said statements.

16. The method of claim 15, wherein said step of calculating said weighted values into said statement weighted values further comprises the steps of:
combining said weighted values of said attributes to mathematically derive attribute weighted totals for said attributes;
selecting said sub-statements related to said attributes, wherein said sub-statements are applicable to said attributes within said taxonomy, and wherein said sub-statements inherit said attribute weighted totals;
multiplying said attribute weighted totals by sub-statement percent weights of said sub-statements to calculate sub-statement weighted values, wherein said sub-statement percent weights are defined by a selection from the group consisting of said voting currency, said votes, and combinations thereof;
combining said sub-statement weighted values of said sub-statements to mathematically derive sub-statement weighted totals for said sub-statements;
selecting said sub-statements linked to statements, wherein said sub-statements are applicable to said statements within said taxonomy, and wherein said statements inherit said sub-statement weighted totals;
multiplying said sub-statement weighted totals by statement percent weights of said statements to calculate statement weighted values, wherein said statement percent weights are defined by a selection from the group consisting of said voting currency, said votes, and combinations thereof; and
combining said statement weighted values of said statements to mathematically derive statement weighted totals for said statements.

17. The method of claim 16, wherein said step of calculating said statement weighted values into agendum weighted values further comprises the steps of:
selecting said statements to affect said agenda, wherein said statements are applicable to said agenda within said taxonomy, and wherein said agenda inherit said statement weighted totals; and
multiplying said statement weighted totals by agenda percent weights of said agenda to calculate said agendum weighted values, wherein said agenda percent weights are defined by a selection from the group consisting of said voting currency, said votes, and combinations thereof, and wherein said agendum weighted values are a numerical score for generating said universal sustainability score.

18. The method of claim 17, further comprising the steps of:
selecting said subjects from the group consisting of said attributes, said statements, and combinations thereof, wherein said subjects are selected by said plurality of networked users;
calculating said weighted values for selected said subjects; and
combining said weighted values for selected said subjects to mathematically derive subject scores, wherein said subject scores are an alphanumeric value indicator for said subject.

19. A method for generating an impact score, wherein said impact score is a numerical indicator of universal sustainability of a subject in relation to applicable statements, wherein said statements support said subject, said method comprising the steps of:
defining said subject, wherein said subject comprises a selection from the group consisting of a person, a place, a thing, and combinations thereof;
utilizing at least one computer processor to generate statements, attributes, and combinations thereof, wherein said attributes may selectively be linked to said statements;
assigning statement percent weights to said statements, wherein said statement percent weights identify the importance of said statements;
assigning attribute percent weights to said attributes, wherein said attribute percent weights identify the importance of said attributes relative to said subject;
inputting raw values into said attributes, wherein said raw values satisfy said attributes;
multiplying said raw values with said attribute percent weights to derive attribute values;
linking together select said statements, said attributes, and combinations thereof;
multiplying said attribute values of said attributes linked to select said statements with said statement percent weights to derive statement values; and
combining together said statement values of said statements applicable to said subject to calculate said impact score.

20. A method for generating a subject score, wherein said subject score is a numerical indicator of a subject, said method comprising the steps of:
defining said subject, wherein said subject comprises a selection from the group consisting of a person, a place, a thing, and combinations thereof;
utilizing at least one computer processor to generate attributes, sub-attributes and combinations thereof, wherein said sub-attributes are linked to said attributes;
assigning attribute percent weights to said attributes, wherein said attribute percent weights identify the importance of said attributes relative to said subject;
inputting raw values into said attributes, wherein said raw values satisfy said attributes;
multiplying said raw values with said attribute percent weights to derive attribute values; and
combining together said attribute values of said attributes applicable to said subject to calculate said subject score.

21. A method for generating a taxonomy, wherein said taxonomy is a modular hierarchy incorporating data contributed by a plurality of networked users, said method comprising the steps of:
contributing data into said taxonomy, wherein said data is selected from the group consisting of sub-attributes, attributes, sub-statements, statements, agenda, and combinations thereof, and wherein said data is contributed by a plurality of networked users utilizing at least one computer processor;
linking said sub-attributes to said attributes;
linking said sub-statements to said statements; and
organizing said data within said taxonomy into a modular hierarchy, wherein said plurality of networked users selectively link said attributes to said sub-statements, and wherein plurality of networked users selectively link said statements to said agenda.
